(19) United States
(12) Patent Application Publication
(10) Pub. No.: US 2017/0001320 A1
(43) Pub. Date: Jan. 5, 2017

(54) DISPOSABLE FLUID DISPENSING HAIR REMOVAL DEVICE

(71) Applicant: The Gillette Company, Boston, MA (US)

(72) Inventors: Matthew James Hodgson, Ramsbury (GB); Anthony William Shorey, Thatcham (GB); Nicola Louise Caton, Reading (GB)

(21) Appl. No.: 15/171,085

(22) Filed: Jun. 2, 2016

(30) Foreign Application Priority Data
Jun. 30, 2015 (EP) 15174581.7

(51) Int. Cl. B26B 21/44; B26B 21/52

(52) U.S. Cl. CPC B26B 21/446; B26B 21/521

(57) ABSTRACT

The present invention relates to a hair removal and fluid application device (1), having flexible hollow handle (10 to contain and expel fluid therefrom, a hair removal means (2) and a fluid dispensing means (3) which are attached to a chassis (4) in a predetermined position such that the hair removal means (2) and fluid dispensing means (3) are used independently of one another.

### FIELD OF THE INVENTION

The invention relates to disposable fluid dispensing hair removal devices which enable a consumer to conduct a hair removal process without the need for additional system components which is low cost and simple to manufacture and convenient to use, particularly in the absence of a source of water and or outside of a bathroom environment.

### BACKGROUND OF THE INVENTION

Reusable hair removal devices which are also capable of dispensing a fluid are known in the art. Such devices typically include one or more fluid dispensing orifices through which the fluid is dispensed via the razor cartridge during the shaving process. The fluid is contained with a replaceable reservoir located in the handle and is expelled there from by a pump which is activated by a push button. Such devices are complex and expensive to manufacture, requiring many parts and are designed to enable the replacement of both the razor cartridge and fluid reservoir. For example see US2013/0145626, US 2013/0145625, US2013/0145601 and WO2011/130372. Such devices further suffer from problems related to microbial contamination over the life time of the device, controlling the delivery of the liquid from the device and ensuring its delivery onto the desired surface. In particular, a problem with such devices is that at least some of the shaving liquid is often removed almost immediately after application during the subsequent hair removal process, thereby minimizing any benefits. Moreover the devices may also be large and cumbersome and do not facilitate portability, transportation and use away from home.

Disposable hair removal devices whereby the razor cartridge cannot be replaced are also well known in the art. These devices are typically slightly less complex versions of the reusable devices, for example by the removal of a pivot between the cartridge and handle, to thereby simplify and reduce the costs of manufacturing. Nevertheless, these devices are still considerably complex to manufacture and require a separate supply of shaving fluid.

There is hence still a need however to provide a disposable hair removal device which also enables the dispensation of a fluid and thereby negates the need for a separate fluid container while reducing the complexity of the device and number of components thereof. There is also a need to provide a device which is cheap to manufacture and to maximize the components capable of being recycled. This is particularly desirable for hair removal processes which take place away from the consumers' home bathroom facilities while traveling and or in the absence of a convenient water supply. There is also a need to provide a device which is easy to effectively use for all body areas.

Attempts have been described in the art to provide disposable hair removal devices which also dispense a fluid. For example EP427889A describes a disposable razor with detachable gel packets secured to the razor handle whereby the packets can be removed from the razor, opened and the contents applied to the skin prior or after the shaving process. This device is not particularly convenient for the consumer as the packets require removal from the device and separate independent application of the fluid. DE 102011117590 describes a disposable razor comprising a removable container for a shaving gel. The shaving gel container is placed on the razor handle and the end is placed on the razor head. Upon applying pressure to the perforations on the container, the container is opened to release the razor gel. However the application of the fluid is not controlled.

US2004/0016126 describes a manually adjustable hair removal and skin lubrication device. The device has a U shaped body which can be manipulated to expel lubricant from the internal reservoir independently or simultaneously during the hair removal process. This device however requires a significant amount of manual dexterity in order to select the desired usage configuration and, in particular, to consistently maintain the desired configuration in order to simultaneously dispense the lubricant and control the razor cartridge during the entire shaving process. The consumer is therefore required to continuously check the configuration and this is particularly inconvenient as it results in an interruption of the shaving process and is difficult when shaving more inaccessible body areas. Moreover, the lubricant and wicking devices are not sealed prior to use and thereby are liable to inadvertent spillage and or contamination.

Despite the availability of fluid dispensing razors, many consumers however still prefer to apply a skin preparation treatment onto the skin prior and or after the shaving process, even if using a liquid dispensing razor. Liquid dispensing razors typically dispense the liquid directly below or above the razor blades or from within the razor cartridge through the razor blades. Consequently, the consumer may not be able to visibly confirm that the liquid has been dispensed on the skin surface to be shaved or control or ascertain how much liquid has been dispensed. The use of the pre-shaving preparation reassures and confirms to the consumer that there is complete and thorough coverage of the skin with the skin preparation prior to shaving. Moreover, the skin is hydrated and lubricated prior to shaving which improves the shaving experience. Similarly, the removal of the composition from the skin following the shave provides an indication to the consumer as to which areas have been shaved.

Consequently, there still exists a need to provide a cost effective, disposable fluid dispensing hair removal device which enables the application of a pre shave or post shave composition in a simple and convenient manner which is easy to use and only requires a low level of manual dexterity and which can be used for all body areas. There is also a need to provide a device which is easy to manufacture and utilizes known manufacturing techniques.

It has now been surprisingly found that disposable hair removal and fluid dispensing devices which are cheap and easy to manufacture, and which do not require expensive tooling equipment, but deliver the desired level of functionality of the consumer products can be provided by a device having a hollow handle to contain fluid, a hair removal means, a fluid dispensing means and a chassis to attach the components to one another such the hair removal means and the fluid dispensing means are used independently of one another.

### SUMMARY OF THE INVENTION

The present invention relates to a hair removal and fluid application device (1) having a flexible hollow handle (12) to contain and expel a fluid contained therein, a hair removal means (2), fluid dispensing means (3) and a chassis (4) to connect said hollow handle (10), said hair removal means (2) and said fluid dispensing means (3) to one another. The hollow handle is releasably attached to said chassis (4) and said hair removal means (2) and said fluid dispensing means (3) are attached to said chassis in a substantially predetermined position such that the hair removal means (2) and fluid dispensing means (3) are used independently of one another.

### BRIEF DESCRIPTION OF THE DRAWINGS

FIGS. 1a and 1b shows perspective front and rear views of a first embodiment of the invention.

FIG. 2 shows an exploded view of the first embodiment of FIGS. 1a & 1b.

FIG. 3 show a cross section of the first embodiment of the invention.

FIG. 4 shows an exploded view of the cross section of a first embodiment of FIG. 3 (without an opening means).

FIG. 5 shows cross sections of a second, third and fourth embodiment of the invention; wherein Nhr and Nfa depict the normal hair removing means and fluid application means plane.

FIGS. 6a and 6b show a partial exploded cross section and a cross section of a fifth embodiment of the invention (hair removal means not shown).

FIGS. 7a and 7b show a partial cross section of a sixth embodiment of the invention (hair removal means not shown).

FIG. 8 shows partial schematic cross section views of the opening of the dispensing aperture with an opening means of the first embodiment (hair removal means not shown).

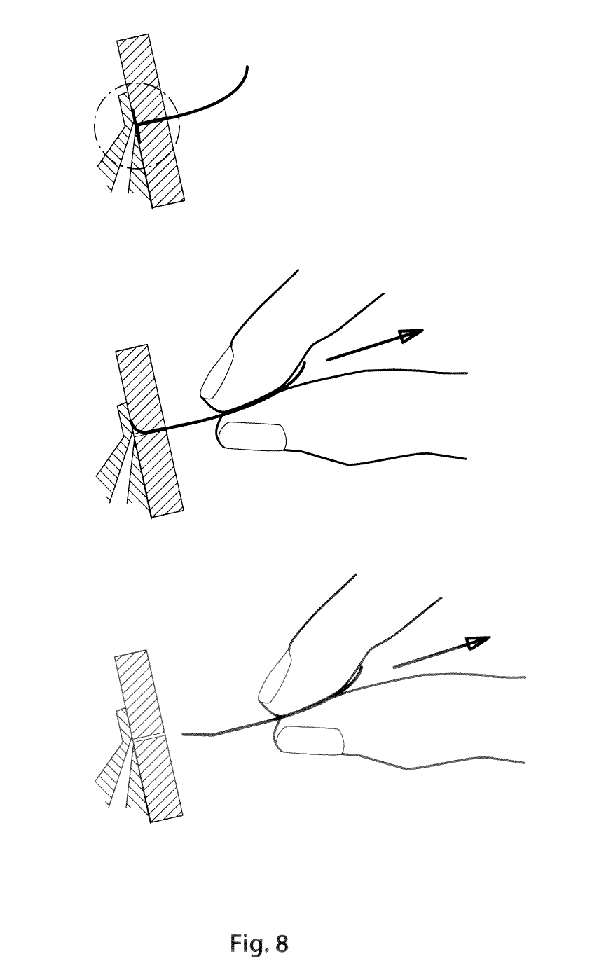

FIG. 9 shows a schematic cross section views of the opening of the dispensing aperture with an opening means (hair removal means not shown) of a seventh embodiment.

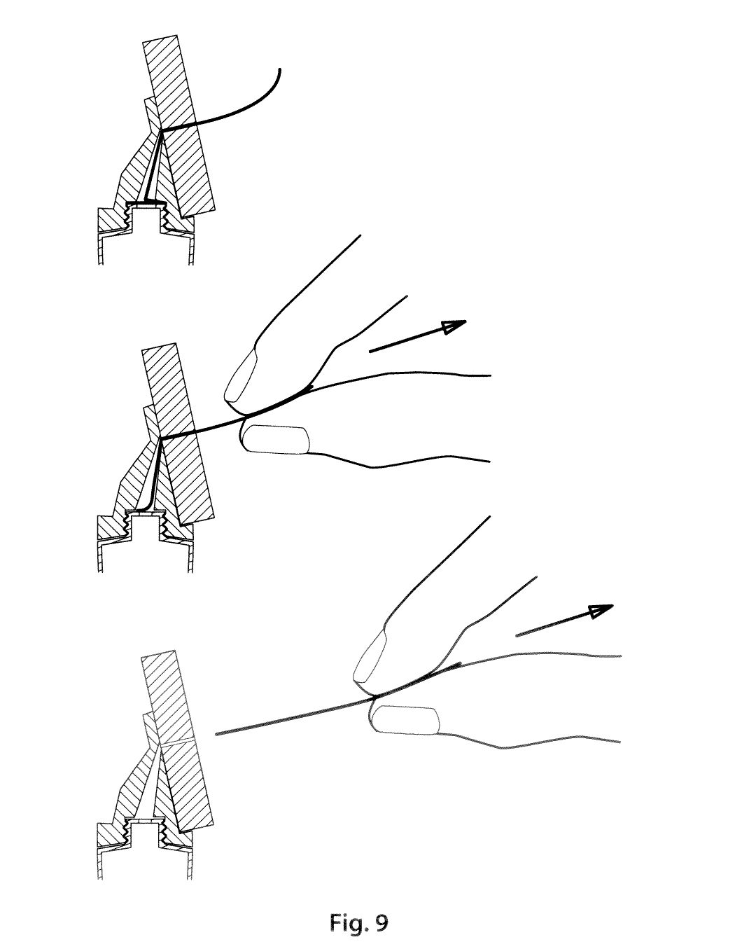

FIG. 10 shows a schematic view of the hair removal means and fluid application means at rest and in use deflected positions.

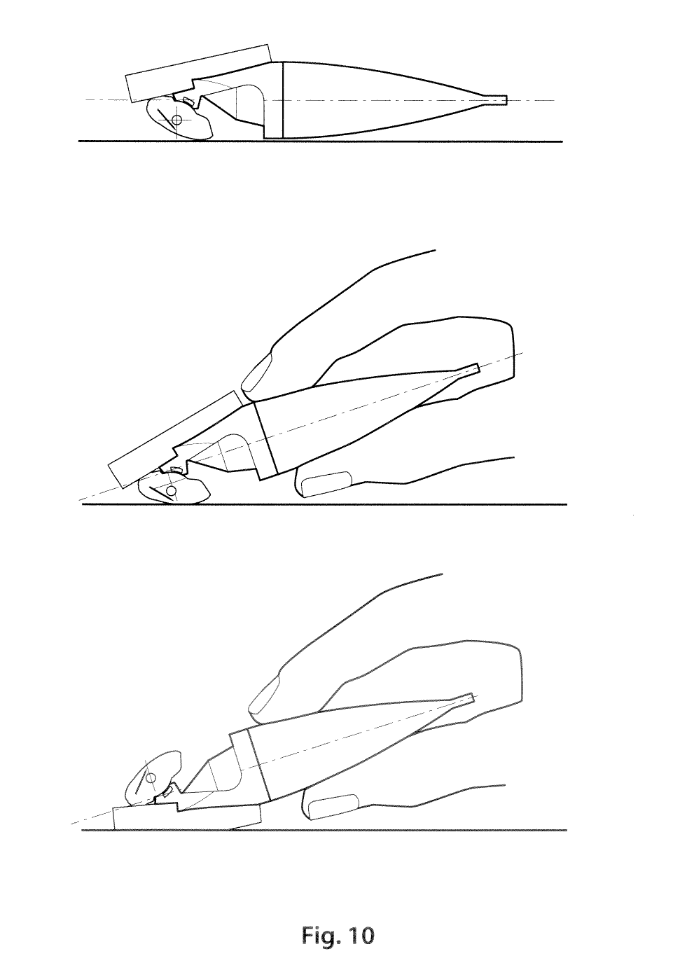

FIG. 11 shows a schematic view of alternative hair removal means and fluid application means at rest and in use deflected positions.

### DETAILED DESCRIPTION OF THE INVENTION

According to the invention the hair removal and fluid application device (1) comprises a hair removal means (2), a fluid dispensing means (3) and a flexible, hollow handle (10) to contain and expel a fluid contained therein. A chassis (4) is provided to connect said hollow handle (10), said hair removal means (2) and said fluid dispensing means (3) to one another. The hair removal and fluid application device (1) may have a front and back surface (7, 8) and may comprise an upper portion (5) and a lower portion (6).

Hair Removal Means

Any hair removal means (2) known in the art may be used herein, such as single or multiple, i.e. at least two blades, or three blades and optionally an associated razor housing or cartridge therefore; foil, scraper or mesh. Preferably, the hair removal means comprises a guard and a cap with at least one blade located in-between the cap and guard. More preferably, the hair removal means (2) comprises a razor cartridge having a housing, a cap and a guard located on the housing and at least one blade(s) positioned between the cap and guard. Embodiments of this type having a single or double blade cartridge are particularly beneficial as they allow shaving debris such as hair, skin and shaving composition to readily pass through the cartridge and thereby prevent clogging.

Fluid Dispensing Means

Suitable fluid dispensing means (3) includes any material capable of dispensing the fluid upon application of the means against a user's skin. The rate of dispensing can be readily controlled by the consumer by regulating the amount of pressure applied to the dispensing means against the user's skin. Preferably the fluid dispensing means (3) should exhibit a skin contacting surface which is soft to the touch to enable multiple applications to the skin without irritation. Moreover, the fluid dispensing means should preferably be resilient and substantially recover their original shape after each application. The fluid dispensing means is also preferably selected so as to enable sufficient absorption and retention of the fluid to then rapidly enable its dispensation over the desired skin areas. In addition the fluid dispensing means should preferably not become permanently discolored or contaminated with the fluid so as to enable multiple fluid dispensing and rinsing and or drying cycles if required while negating contamination.

Suitable materials include foams, including open and closed cell foams, wovens, nonwovens, single or multiple perforated or apertured films, rigid or semi rigid molded plastic and combinations thereof. Suitable materials include thermoplastic elastomer, thermoplastic vulcinates such as Santoprene™, silicones and polyurethanes. The fluid dispensing means may comprise a single layer or multiple layers of material which may be the same material or different. Such layered embodiments may be layered vertically on top of one another whereby each layer extends towards the surface facing the skin contacting surface or layered adjacent one another each layer directly facing the skin contacting surface.

Preferably, the fluid dispensing means (3) is provided by a foam, more preferably an open celled foam, more preferably an open celled foam having a hydrophilic surface. Suitable materials include natural sponge, cellulose, polyethylene, polyurethane and other synthetic foam materials known in the art and commercially available. Foam materials are particularly advantageous as they may function to both retain and dispense and to spread the fluid dispensed onto the skin without causing skin irritation, thereby enabling a more controlled application of the fluid onto the user's skin by the consumer. Open celled foams are also easily rinsed after use for disposal or reuse.

In one preferred embodiment, the fluid dispensing means is selected such that it may also function as a post hair removal debris collector so that it will act to collect at least some of the hair and or fluid remaining on the skin after the hair removal process. Suitable materials for such embodiments include foams preferably open celled cellulose foams preferably formed from ether based polyurethanes. Such foams may have a pore size of about 60 ppi and a density of from about 18 to about 20 kg/m³. Alternatively a combination of materials may be utilized in order to provide both fluid dispensing and debris collection. Suitable combinations include for example open and closed cell foams, or a foam and non woven sheet material composite.

The fluid dispensing means preferably has a skin contacting surface area from about 0.8 cm² to about 35 cm², preferably from about 5 cm² to about 15 cm², more preferably from about 8 cm² to about 10 cm².

The fluid dispensing means may be provided with at least one aperture or opening in fluid communication with the hollow handle containing fluid and optionally the chassis as discussed hereinafter to facility fluid transportation from the handle to the fluid dispensing means.

Fluid Containing Hollow Handle

The hair removal and fluid application device (1) further comprises a flexible hollow handle preferably a blow molded handle (10). The handle (10) functions to both contain and expel the required amount of fluid and also to enable a user to hold and control the device and to securely locate and position the hair removal means (2) and the fluid dispensing means (3) onto the desired skin surface to be treated. The hollow handle is sufficiently rigid to enable the user to securely hold the device but also exhibits sufficient and flexibility and preferably resiliency as a reservoir for containing fluids. This facilitates the expulsion of the fluid from the handle upon the application of pressure by the user while preferably regaining the reservoirs' original configuration after the removal of the application of pressure independent of whether the handle contains fluid or not. The hollow handle is provided as a single component and does not include embodiments where the fluid is contained within a sachet or fully flexible reservoir which is contained within a separate container, support body or bottle such as a bag in bottle, in order to provide the required degree of stiffness.

The handle (10) typically has major front and back surfaces and optionally at least one bottom edge (15) and at least one dispensing aperture (as discussed hereinafter). Alternatively the handle may have a substantially tubular shape. The handle (10) is preferably formed by blow molding or seamless extrusion techniques known in the art and may comprise one single sealed edge typically the bottom edge has a dispensing aperture at the top edge which may be provided by injection overmolding techniques and no additional perimeter edge seals. The handle (10) may be of any shape but is typically tubular as for example utilized in the cosmetics industry as squeeze tubes.

In order to contain the fluid and to enable the consumer to hold the reservoir in order to use the hair removal means and or fluid dispensing means in a controlled manner across all skin surfaces in both wet and dry environments, the hollow handle (10) may be provided from any material or combination of materials suitable to contain a fluid i.e. liquid impervious materials or composites and which is flexible, and preferably resilient provided as a single component. This enables the handle to provide the required both sufficient stiffness while retaining sufficient flexibility to be held securely by a user to utilize the device in a controlled manner without the need for a pump or push button activator or complex multicomponent parts. In one embodiment, the handle is formed from a polymer such as HDPE, MDPE, LDPE, PP, PET, PS, PC, PVC, PE or mixtures thereof, or laminates or other commercially available materials which are preferably capable of being blow or injection molded and or extruded. The material may be selected depending on the internal capacity of the handle and the density and the volume of the fluid to be contained therein and the strength and flexibility required for the particular application. Suitable manufacturing techniques include blow molding, extrusion, injection molding and over molding and combinations thereof.

Typically the handle has a substantially uniform thickness as achieved by standard blow molding techniques of from about 0.05 mm to about 1 mm, preferably from about 0.07 mm to about 0.8 mm, more preferably from about 0.3 mm to about 0.6 mm.

The handle material may be transparent or opaque; the latter may have particular application to prevent fluid degradation, whereas the former enables the consumer to readily observe the consumption of the fluid. Embodiments with partial transparent or opaque portions are also envisioned. The outer surface of the handle and or chassis or at least a portion thereof such as the major front or rear surface(s) or portion thereof, may be coated or printed with an additional material to provide a consumer preferred tactile surface such as a woven, non woven, and or polymers such as silicone and rubber. In addition the outer surface of the handle and or chassis may be provided with indicia to communicate to the consumer information such as the contents of the handle, usage instructions, recommended handling position to hold and dispense the fluid.

The handle (10) may comprise one or multiple i.e. two or more separate fluid compartments to enable different compositions to be applied and or to enable multiple applications of the same or similar fluid composition(s). Each separate fluid compartment will preferably have a dispensing aperture and preferably an opening means or tab associated with the handle as described hereinafter. The multiple compartments may be provided by forming a handle having one compartment which is divided into 2 compartments by the provision of an additional seal or formed in situ for example using blow molding techniques or other known methods in the art.

The handle and or chassis may preferably be surface treated on at least one major front and or rear surface with a suitable water repellant or hydrophobic material such as a wax or polymer(s) to improve consumer handling particularly in the presence of water and to improve the tactile feel or grip of the handle and or chassis and to more readily enable printing.

### Capacity

The internal capacity of the handle may be selected dependent upon the end use and intended usage regime in other words whether it is intended for single use, and or multiple use and or specific body areas. For example, the capacity may be selected for a single application of a post care skin treatment composition or alternatively for a multiple use pretreat shaving composition. For beauty and grooming applications, the hollow handle may have a capacity of from about 1 ml to about 500 ml, preferably from about 50 ml to 250 ml, or alternatively from 1 ml to 15 ml or from 10 ml to 25 ml. The fluid reservoir is typically filled to at least about 75%, preferably at least about 80% capacity in order to prevent inadvertent spillage upon opening.

### Chassis

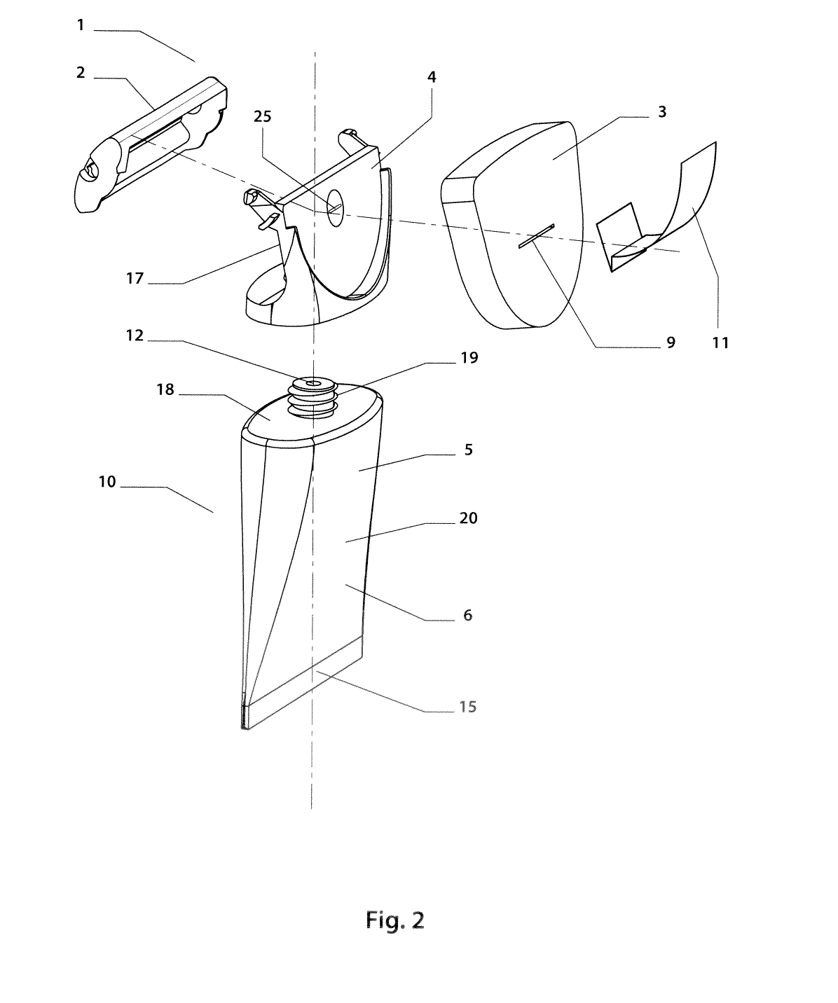

In order to conveniently construct the device, and ensure the desired configuration and attachment of the individual components, namely the handle (10), hair removing means (2) and fluid dispensing means (3), the device further comprises a chassis (4) as shown in FIG. 2. The chassis (4) provides a simple means of attachment and disposal of the hair removal means (2) and fluid dispensing means (3) to the handle and thereby facilitate recycling. The attachment of the hair removal means (2) and the fluid dispensing means (3) to the chassis (4) may be permanent or releasable.

Preferably, at least one of said hair removal means (2) and said fluid dispensing means (3) is permanently attached to said chassis (4), more preferably both of said hair removal means (2) and said fluid dispensing means (3) are permanently attached to said chassis (4).

In another embodiment, the hair removal means (2) and or fluid dispensing means (3) are releasably attached to the chassis to enable their respective removal and replacement. In another embodiment the hair removal means (2) is releasably attached to the chassis (4) and the hair fluid dispensing means (3) is permanently attached to the chassis (4). The chassis is releasably attached to the handle (10), optionally over the neck portion (19) of the handle (10), if present.

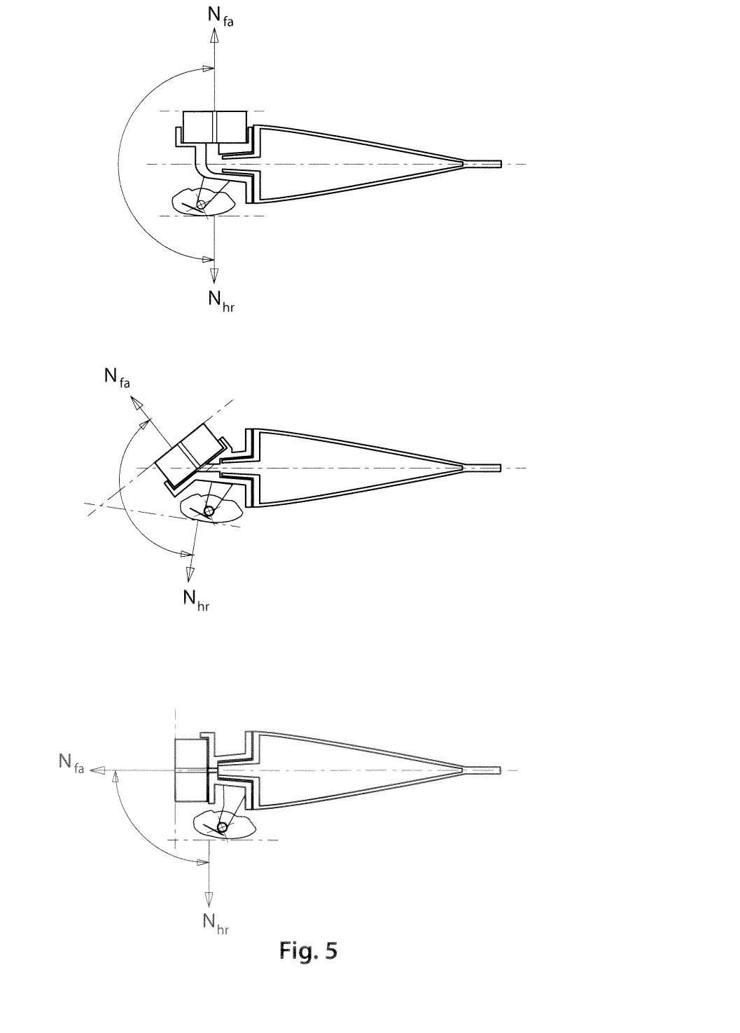

Any suitable means may be independently selected to permanently or releasably attach the fluid dispensing means (3), hair removal means (2) and the handle (10) to the chassis (4), such as adhesives, ultrasonic welding, double sided tape, rivets, clips, screw thread or other mechanical means and combinations thereof. Alternatively, the chassis (4) may be formed in situ as part of the handle blow molding process of the handle. Similarly, suitable fluid dispensing means (3) and or hair removal means (2) may be co molded to the chassis in order to attach thereto. The presence of the chassis (4) readily enables the desired predetermined configuration of the fluid dispensing means and the hair removal means as discussed herein in order that they may be used independently from one another. In one preferred embodiment the chassis (4) provides at least one surface preferably a front and rear surface (16, 17) to which the hair removal means (2) and fluid dispensing means (3) are positioned respectively. The front and rear surfaces (16, 17) may be substantially parallel to one another or the surfaces may be at an angle towards one another as shown in FIG. 5.

The chassis (4) may provide a hinge or bearing that pivots around an axis defined by the hinge or bearing in order to facilitate maximum contact of the hair removal means and or fluid dispensing means to the skin along the contours of the body. The chassis may extend along at least a portion of the top edge of the hollow handle.

The chassis may be provided from any suitable materials including those listed above for the handle such as ABS, PC, PS, HDPE, PP and using any known manufacturing processes such as injection molding, extrusion blow molding and overmolding.

The chassis may provide a liquid pathway from the handle to the fluid dispensing means typically in the form of a liquid channel (25) extending through the chassis (4). In such embodiments the dispensing aperture of the handle may be sealed remotely from the hollow handle's dispensing aperture within the chassis i.e. the liquid channel (25). The seal may be located at any point in the chassis liquid pathway channel (25), preferably towards the terminal end of the fluid pathway towards, preferably adjacent the fluid dispensing means (3) which is remote from the handle aperture. The chassis may also function to provide the opening means for the sealed aperture as discussed hereinafter.

### Hair Removal Means and Fluid Application Means Orientation

The hair removal means (2) and fluid application means (3) may be positioned at any suitable location on the chassis in a predetermined position to one another, such that the hair removal means and fluid dispensing means may be used independently of one another and without any interference. The hair removal means and fluid dispensing means are preferably attached either permanently or releasably in a predetermined position which cannot be significantly altered. This enables the user to apply fluid to an area of skin utilizing the fluid application means and ensure sufficient application thereof before or after similarly the removal of hair therefrom utilizing the hair removal means on the area of skin without interference. This enables the usage of either the hair removal means or fluid application means without any interference from the other.

The hair removal means (2) and fluid dispensing means (3) are preferably located on the front and back surfaces (7, 8) respectively of the device preferably both being located on the upper portion of the device. The hair removal means (2) and the fluid dispensing means (3) may be located on substantially opposing surfaces of the device (1) for example on the front and back surfaces of the device. In an alternative embodiment the hair removal means and fluid dispensing means may be located substantially perpendicular to one another i.e. front or back surface and top surface of the device respectively as shown in FIG. 5. For each embodiment the hair removal means and the fluid dispensing means are preferably located in the upper portion of the device. This enables the hair removal means and the fluid dispensing means to be contained on a single device while ensuring that they can be used independently from one another without any interference, thereby enabling the consumer to effectively apply the fluid composition to the desired body surfaces before or after use of the hair removal device and allowing the consumer to switch between fluid application and hair removal rapidly. The hair removal means (2) and the fluid dispensing means (3) may be positioned such that they are substantially aligned about a horizontal plane. Alternatively, hair removal means and the fluid dispensing means may be offset with either the hair removal means being positioned at least partially above the fluid dispensing means or vice versa. In another embodiment the hair removal means and or fluid dispensing means may independently be positioned at an angle to the vertical plane as shown in FIG. 5.

In one embodiment, the fluid dispensing means (3) and or hair removal means (2) independently extend along at least a portion, preferably at least 50% more preferably at least 75%, even more preferably at least 90% of the width of the front and or rear surface and or top surface of the device and or chassis respectively. In another embodiment the fluid dispensing means (3) and or hair removal means (2) independently extend along at least 95%, preferably at least 99% of the width of the front or rear surface (7,8).

The device preferably provides sufficient rigidity to the device to enable the consumer to hold the device and apply and dispense the fluid onto the skin or apply the hair removal device onto the skin. This may be provided from the handle and or the chassis, preferably the handle or a combination thereof.

Both the hair removal and fluid application means have an associated skin contacting surface. In order to maximize performance, it is desirable that in use the hair removal and fluid application means achieve maximum contact with the respective skin contacting surface. This requires that the hair removal means and fluid application means generally follow the contours of the skin surface, where they are used, e.g. leg, chest, and face. This may be achieved by connecting the hair removal means and fluid dispensing means to the chassis using a hinge or bearing that pivots around an axis defined by the hinge or bearing.

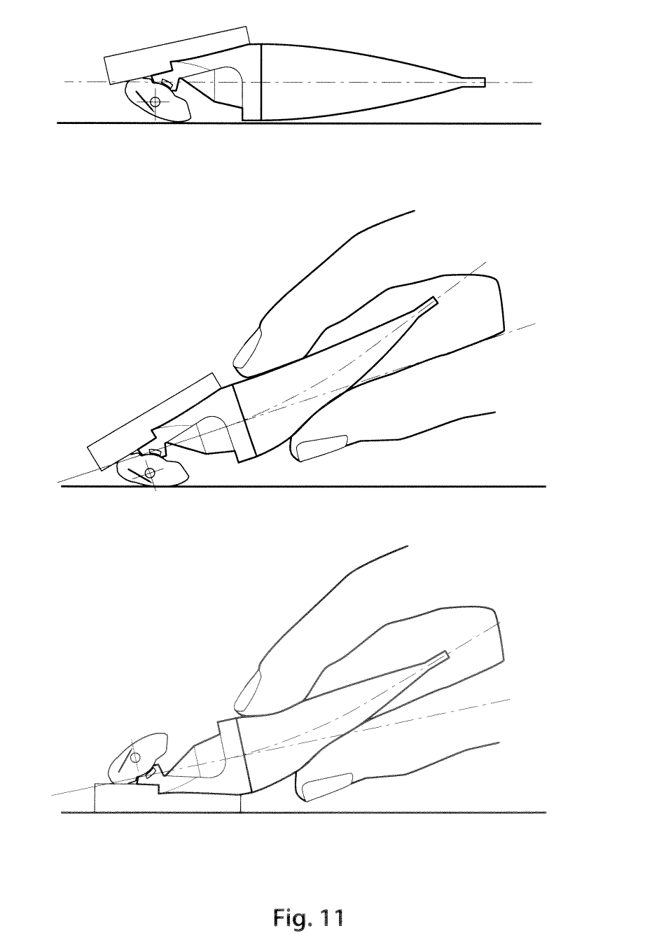

Alternatively, the disposable hair removal and fluid application device as described herein follows the contours of the skin surface by enabling a deflecting motion of the device in use via the flexible handle itself with respect to its at rest position i.e. in the absence of the application of any external forces to the device when the device is resting on a horizontal surface. The deflection motion of the device may occur in a portion of the upper and or lower portion of the handle, preferably at a deflection point or along the entire length of the handle between the lower portion where it is held by the user and below the upper portion where the hair removal and fluid application means are preferably located. In contrast to conventional devices, the handle described herein enables deflection in two opposing directions from its at rest position, depending on the orientation in which the hair removal and fluid application device is held and which of the two means are in use by the consumer. The in use deflection occurs in response to the user holding the device, preferably at the lower end and exerting a force onto the entire device when pushing it against the skin surface to apply either a fluid or remove hair which results in the in use hair removal deflected position and or the in use fluid dispensing in use deflected position as shown in FIG. 11. The typical average mean load exerted by a user is from about 120 g to about 200 g and thus the reservoir is preferably selected such that it will deflect upon application of such forces.

The in use deflected positions may be provided by the selection of the material of the handle or conventional type of pivot or hinge connecting the hair removal means and fluid dispensing means to the chassis.

In one embodiment the hair removal and fluid dispensing device has a vertical plane of symmetry. The at rest and in use deflected positions of the device may be determined with respect to the vertical plane of symmetry as shown in FIG. 11.

### Hollow Handle Dispensing Aperture and Seal

The device, typically the handle is provided with a dispensing aperture (21) which is sealed prior to use to enable transportation of the device without fluid leakage therefrom. Upon opening of the seal of the aperture a fluid pathway between the handle (10), and optionally the chassis (4) and the fluid dispensing means (3) is formed. As discussed herein, the hollow handle may comprise a main body and a neck portion (19) and the sealed aperture (21) may be located in the neck portion (19) of the hollow handle (as described herein) if present or in the chassis.

Any suitable seal which is readily opened by the user and which optionally may be resealed may find application herein. In one embodiment the aperture is provided with a frangible seal, which can be readily broken prior to use to create the fluid pathway. The seal may be a single use opening means such as a frangible seal or may be resealable to enable storage without any leakage and subsequent reuse of the hollow handle. Suitable frangible seals include pull tab, pull string, foil loop, snap seals, piercer, and pressure burst seal and tear strip. Examples of re-usable seals include screw tops; adhesive tabs, hook and loop fasteners such as Velcro™, plastic zips such a Ziploc™, press seals, stopper caps or plugs, valves such as squeeze valves and one way valves, and other types of commercially available sealing methods as found on drink containers for example and known to the skilled person. Particularly preferred are pull tabs, one way valves and stoppers, one way valves providing the additional advantage of providing fluid flow regulation.

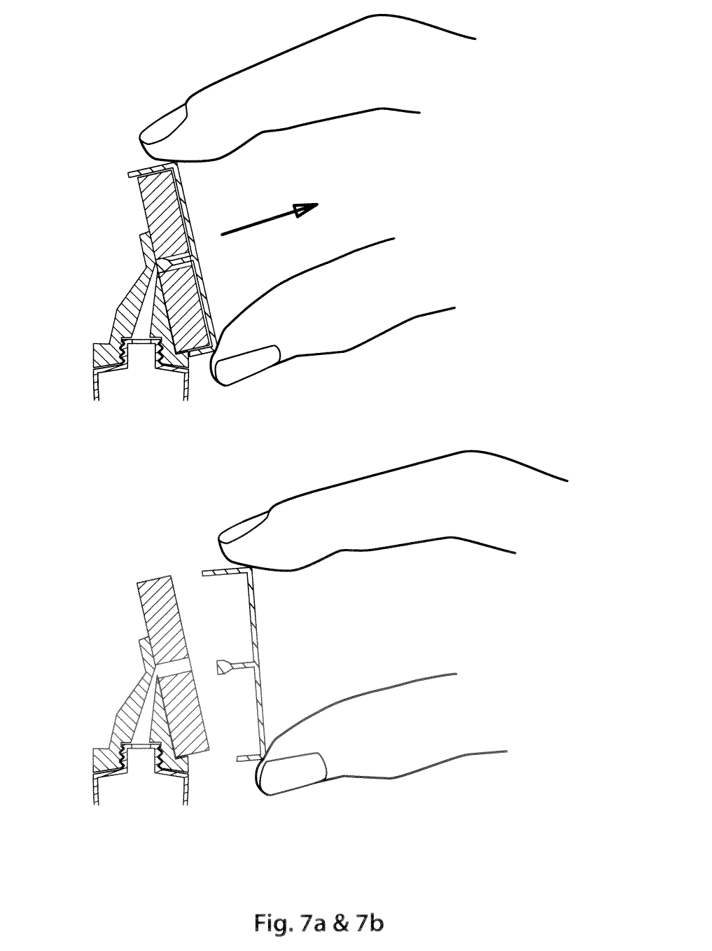

In one embodiment the chassis may be provided with removable insert stopper as shown in FIGS. 7a and 7b. The stopper insert provides a seal to the handle aperture which is opened by its removal thereby functioning as an opening means. In one embodiment (not shown) the stopper insert may extend to and preferably beyond the handle aperture into the handle cavity forming a liquid seal between the handle and insert stopper.

### Opening Means

The hollow handle (10) and or chassis (4) may further be provided with an opening means or tab (11) to open the sealed aperture of the handle (10). The opening means or tab (11) may be readily grasped by the consumer, typically at its distal end or by the tag, if present, to initiate the opening process. Typically, the consumer will pull on the opening means generally in a direction away from the handle and thereby rupture the sealed aperture to create an opening upon removal or partial removal of the opening means there from. The fluid contained in the handle may then be dispensed by the user.

Accordingly, the opening means (11) may be releasably attached to the seal. The opening means or tab may have a proximal end (22) and a distal end (23). At least a portion of the proximal end (22) is releasably attached to the sealed aperture and the distal end (23) extends outwardly there from. Any means may be used to releasably attach the opening means (11) to the seal including but not limited to adhesives, heat and pressure sealing, heat sealing being preferred.

The opening means may be provided from any suitable material such as the same or different material or film used for the reservoir material as described hereinabove. Suitable materials include but are not limited to metal, cotton, polymers such as polyester, nylon, rayon, plastics, cellulose based materials such as cardboard and paper which may be laminated, coated or waxed. The opening means may be flexible or rigid.

The opening means may comprise a single tab, string or thread which extends from said aperture and terminates at a point distal there from. Alternatively, the opening means may be a tab, string or thread which extends from said aperture to form a loop. In such embodiments, the proximal end of the loop may be releasably attached to the frangible seal. The distal end may also be attached to the frangible seal. In one embodiment, the tab may be provided with at least 2, preferably at least 3, more preferably at least 4 tines, in at least a portion of the proximal end of the opening means. The tines may be present in the portion of the proximal end located in the sealed aperture and may extend into the interior cavity of the reservoir. The tines if present may also extend into a portion of the distal end. The tines may assist in the creation of a more uniform aperture opening or where desirable the creation of more than one aperture upon removal of the opening means from the reservoir. Such multiple apertures openings may assist in a more uniform distribution of the fluid upon dispensing from the hollow handle onto a surface.

For embodiments where the opening means or tab terminates at a point distal from the sealed opening, the tab may further comprise a tag attached thereto. The tag is preferably substantially wider than the distal end of the opening means or tab to provide a larger surface area for the consumer to grasp and subsequently pull and remove or at least partially detach the opening means from the sealed edge. In an alternative embodiment, the tag may be in the form of a loop attached to the distal end of the opening means to enable the consumer to grasp and pull on the opening means. The tag may be any shape and preferably have a width or diameter of at least 0.1 mm, preferably at least 2 mm, more preferably at least 5 mm, even more preferably from 2 mm to 40 mm, most preferably from 5 mm to 20 mm. The width may be uniform or it may be tapered. For embodiments wherein the distal end of the opening means is in the form of a loop, such a tag may be provided at substantially the midpoint of the loop to provide additional assistance to the consumer to grasp the opening means. For embodiments wherein the opening means is a string or thread, the tag may be formed by providing a knot or loop at the distal end of the opening means. The tag may be provided from the same or different material as the opening means. In one embodiment the tag is formed from a different material preferably so as to provide a consumer preferred tactile surface.

The opening means or tab may be provided in an unfolded or folded configuration, which may be held in place by the tab if present and which is unfolded prior to use.

The opening means or tab and or tag may be provided with indicia to indicate to the consumer, the location of the tab, and or the preferred gripping location and or the direction to pull the means or tab to open and at least partially detach or remove the tab from the reservoir. Indicia may be in the form of differentiated colors and or symbols.

A portion of the proximal end (22) of the opening means or tab (11) may extend beyond the aperture into the interior cavity (21) of the handle (10) to further ensure the attachment of the opening means (11) to the handle. The opening means or tab (11) located in the interior cavity (24) of the handle may have the same or different shape as the distal portion of the opening means or tab which extends outward from the handle. In one embodiment, the portion of the proximal end which extends into the cavity of the handle is in the form of a loop. In such embodiments, the distal end of the opening means extending from the sealed dispensing aperture may or may not also be in the form of a loop.

The portion of the proximal end of the opening means that extends into the interior cavity of the handle may be attached or partially releasably attached to the interior surface of the reservoir. For embodiments wherein the opening means is a loop, the distal portion may also extend into the handle interior.

In one embodiment, the portion of the proximal end of the opening means or tab (11) in the interior cavity (24) of the reservoir has a width which is larger than the portion of the proximal end of the opening means at the aperture. Alternatively, the portion of the proximal end of the opening means in the interior cavity may be larger than the distal portion of the tab extending outward from the aperture. While not being bound by theory it is believed that increasing the width portion of the proximal end of the opening means in the interior cavity of the reservoir results in a greater force being exerted upon the sealed aperture as the consumer pulls on the distal end of the opening means. This thereby further improves the opening of the sealed aperture upon removal or partial removal of the opening means from the reservoir and optionally also may remove any debris present such as adhesive. The portion of the proximal end of the opening means or tab which extends into the interior cavity of the reservoir may be provided from a different material to the proximal end extending outward there from. The material will be selected to be inert towards the fluid contained within the reservoir. For embodiments wherein the distal end is provided by a string or thread, the width may be increased by the provision of knots or at least one tag.

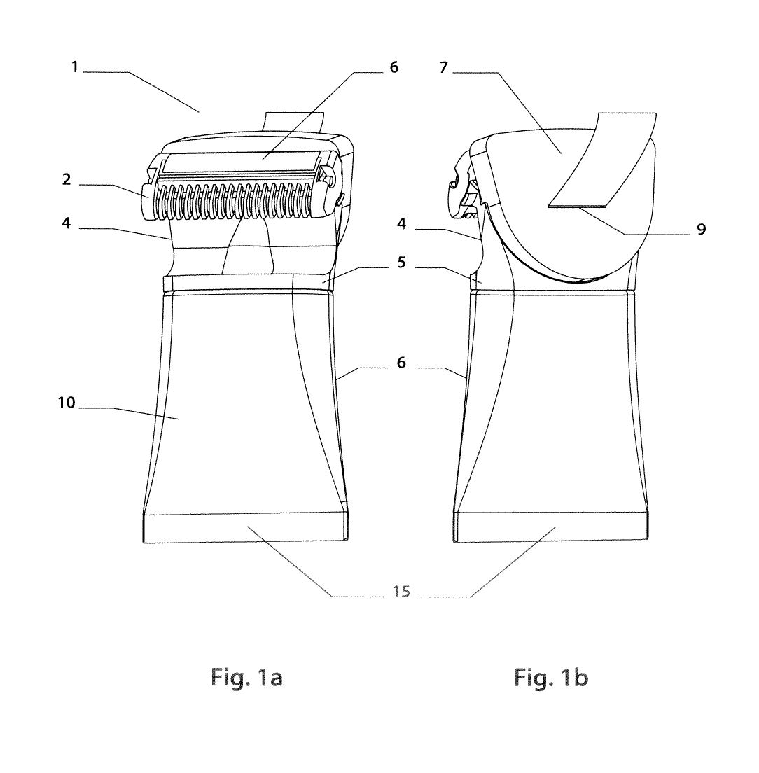

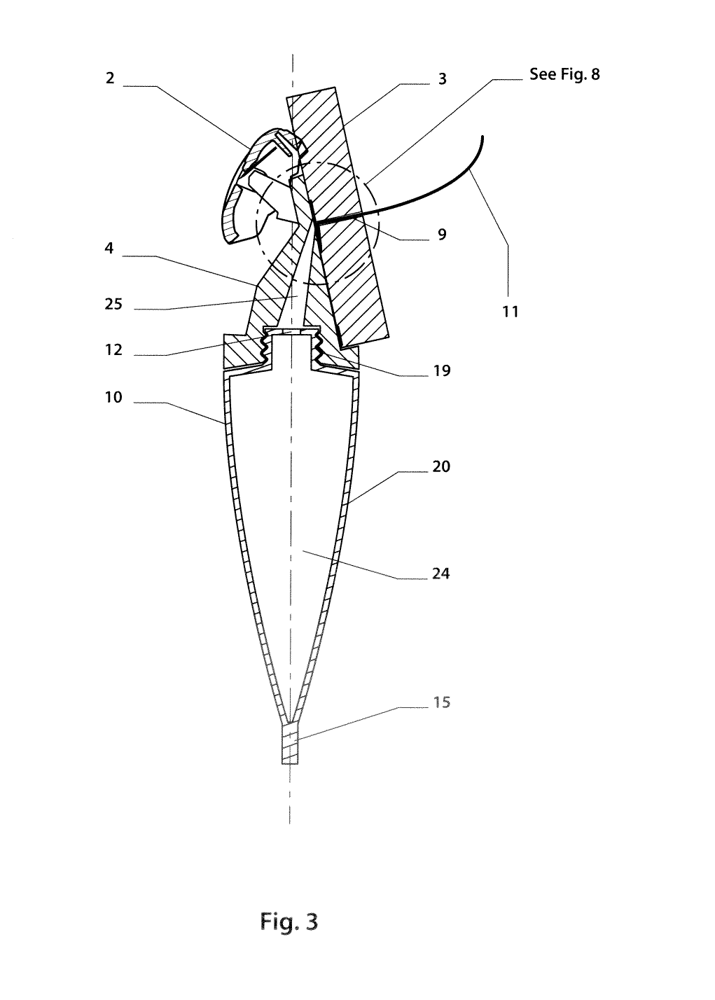

In a preferred embodiment the opening means extends from the handle through the dispensing means (3) at least to the front surface of the device so that the distal end or tag can be readily accessed by the consumer as shown in FIGS. 1b, 3 & 9. In such embodiments the fluid dispensing means (3) may be provided with at least one opening (9) sized to enable the opening means (11) to be passed through the fluid dispensing means (3).

In an alternative embodiment, the chassis itself may function as an opening means. In such embodiments the chassis may for example be rotated about its vertical axis or is pushed vertically down onto the hollow handle, for example both of which break the seal of the dispensing aperture of the handle (10).

In yet another alternative embodiment, the opening means may be provided as a separate component to the hair removal and fluid application device (1) such as an implement designed to break or pierce the seal.

### Handle Neck Portion

In one preferred embodiment, the hollow handle comprises a main body (20) which is further provided with a neck portion (19) extending there from. The presence of a neck portion (19) enables improved fluid flow control and may also enable improved connection with the chassis. The sealed dispensing aperture may be located in the body portion of the handle or preferably it may be located in the neck portion (19) towards the fluid dispensing means as shown in FIG. 3. The neck portion (19) of the hollow handle may be attached to the chassis (4), housing the fluid dispensing means (3) and the hair removal means (2) by any suitable described hereinabove to attach the chassis (4) to the handle (10).

The neck portion (19) is preferably located substantially at the midpoint of the width of the main body (20) extending from the top edge thereof. Alternative configurations include embodiments where the neck portion (19) is offset from the midpoint or located towards one of the upper corner edges of the main body (20).

The neck portion (19) may have any suitable shape and may be symmetrical or unsymmetrical and is preferably selected to enhance the flow of fluid towards the opening. The neck portion (19) may have substantially linear sides or curved sides which may be substantially vertical or at a gradient to provide a tapered neck which aids in the funneling of the fluid out of the reservoir.

The neck portion may extend through a portion of the chassis (4) towards the fluid dispensing means (3). Typically the neck portion (19) may extend within the liquid pathway channel of the chassis (4) and even more preferably may extend at least a portion within or onto or through the fluid dispensing means (3) via an opening therein and thereby create a fluid pathway between the handle (10), chassis (4) and the fluid dispensing means (3). The opening means may be located in the neck portion (19) if present.

### Cap/Cover

The hair removal and fluid application device may further comprise a cap(s) and or cover (s) and or disposable seal or release liner to protect the hair removal means and or fluid dispensing means prior to use, during use and after use for multiple use embodiments. Any suitable cap or seal may be used such as flow wraps. The cover may in addition completely cover and enclose the device.

In one embodiment the cap may provide the sealing means such as a stopper insert for the fluid reservoir aperture as shown in FIGS. 7a and 7b. In such embodiments, the cap is provided with a extending stopper which seals the fluid pathway from the fluid dispensing means at the handle aperture or at some point along the fluid pathway. In another embodiment the cap or cover may provide the opening means.

### Fluid

The reservoir comprises a liquid, gel or paste which may comprise skin and or shaving care actives and or hair removal or depilatory compositions. The compositions may be aqueous, water in oil or oil in water emulsions.

It has been found that when selecting a composition to be used in hair removal devices, it can be particularly desirable to select a composition which is sufficiently thick and viscous that it will not run off the skin or razor after being dispensed. Additionally, moisturizing compositions can be desirable for use in a fluid dispensing hair removal device to allow for multiple benefits, including but not limited to hydration of the hairs prior to shaving, moisturization of skin during the hair removal process, lubrication of skin to reduce friction during the shave, and so forth. Those of skill in the art will understand that moisturization can include hydration of the skin or hair or occlusion of the skin and or hair, or lubrication of the hair or skin to increase glide and reduce friction between the fluid dispensing device and skin.

### Water

The shave care composition of the current invention comprises water. In one embodiment, the shave care composition comprises at least about 30% by weight water. In an alternate embodiment, the shave care composition comprises at least about 40% by weight water. In an alternate embodiment, the shave care composition comprises at least about 50%, more preferably at least 60%, even more preferably at least 80% and even more preferably at least 90% by weight water. Compositions having high levels of water enable the device to be used without the necessity for an additional water source to apply or remove the composition from the skin after application.

### Lipophilic Skin Conditioning Agent

Shave care composition of the present invention may comprise one or more lipophilic skin conditioning agents. The concentration level of the skin conditioning agents either singularly or collectively may range from about 1% to about 50% by weight of the base composition, preferably about 10% to about 40%, and more preferably from about 13% to about 30%. Exemplary skin conditioning agents include hydrocarbons, polymeric hydrocarbons, esters, ethers, and silicones selected from the group consisting of alkyl ethers, mineral oil, isoparaffin, greater than C20 hydrogenated polyisobutene; and an ester composed of a branched C16-C22 alkyl chain and a mono alkyl group consisting of a linear or branched C1 to C6 alkyl chain. Some preferred skin conditioning agents comprise isostearic acid derivatives; for example, isostearyl isostearate, isopropyl isostearate, isopropylpalmitate, isopropylmyristate, PPG-15 Stearyl Ether, petrolatum, dimethicone and dimethoconol and mixtures thereof.

In one embodiment, two or more hydrocarbon phases are preblended prior to emulsification. It has been found that pre-blends of such ingredients can lead to improved skin feel. Examples include petrolatum blended with mineral oil or isopropylpalmitate.

The skin conditioning agents may also help to reduce the coefficient of friction for compositions provided herein. The reduction in friction can decrease the potential for skin irritation that can arise from contacting the skin one or more times with a hair removal device such as a razor blade. Employment of the skin conditioning agent in this context may also permit formulation flexibility regarding the type and concentration level of lubricants that are included in the shaving preparations.

In one embodiment of the invention, particle size of the dispersed phase skin conditioners has an average particle size of 95% of the dispersed phase mass below 20 microns, preferably below 15 microns, more preferably below 10 microns and most preferably below 5 microns. Particle size as measured using a Horiba particle size analyzer and reported as D 50 values. While not wishing to be bound by theory, the smaller particle size is very important for the dispersed phase skin conditioners to be retained on the skin during shaving especially when the shaving composition is dispensed in front of the razor blades or upon re-stroke of the razor when the composition has been deposited on the skin. It is recognized that the skin is not a flat surface and smaller particles can deposit and reside in the recessed areas of the skin and around the hair follicle more easily than larger particles.

### Thickening Agent

The fluid composition may contain one or more thickening agents, from about 0.1% to about 5%, alternatively from about 0.1% to about 4%, alternatively from about 0.25% to about 3%, by weight of the composition.

Non limiting classes of thickening agents include those selected from the following: Carboxylic Acid Polymers, Crosslinked Polyacrylate Polymers Polyacrylamide Polymers, Polysaccharides, Clays and Gums, and mixtures thereof when appropriate. In one embodiment, compositions of the present invention include a thickening agent selected from carboxylic acid polymers, crosslinked polyacrylate polymers, polyacrylamide polymers, polysaccharides, and mixtures thereof, more preferably selected from carboxylic acid polymers, polyacrylamide polymers, polysaccharides, and mixtures thereof.

Preferred thickening/suspending agents include electrolyte sensitive polymers that are shear thinning when in solution. Shear thinning is property that makes a liquid easy to spread and pump. We have found that electrolyte sensitive polymers have desired performance profiles. While not wishing to be bound by theory, the electrolyte sensitive polymers interact with the residual surfactant or electrolyte left on the skin and release the lubrication agents and/or suspended conditioning agents for spreading across the razor and across the surface of the skin. Preferred electrolyte sensitive polymers include but are not limited to: Polyacrylamide, Hydroxyethyl Acrylate/Sodium Acryloyldimethyltaurate Copolymer, Sodium Acrylate/Sodium Acryloyldimethyl Taurate Copolymer, Ammonium Polyacrylate, Sodium Acrylate/Acryloyldimethyltaurate/Dimethylacrylamide Crosspolymer, Hydroxyethyl Acrylate/Sodium Acryloyldimethyltaurate Copolymer which can be purchased from Seppic or Carboxylic Acid Polymers (Carbomers) such as Ultrez 10, Carbopol 934, Carbopol 980 and ETD 2050 which can be purchased from Lubrizol or Ammonium Acryloyldimethyltaurate/VP Copolymer, Sodium Acryloyldimethyltaurate/VP Copolymer, Ammonium Acryloyldimethyltaurate/Beheneth-25 Methacrylate Crosspolymer, which can be purchased from Clariant. The most preferred electrolyte sensitive polymer is Polyacrylamide available as Sepigel 305 (Polyacrylamide & C13-14 Isoparaffin & Laureth-7).

### Emulsifier

The fluid composition may contain one or more emulsifying agents, from about 0.1% to about 20%, alternatively from about 0.5% to about 15%, alternatively from about 1.0% to about 12%, by weight of the composition. Non limiting examples of surfactants for emulsification for use herein are disclosed in McCutcheon's, Detergents and Emulsifiers, North American edition (1986), published by Allured Publishing Corporation; and McCutcheon's, Functional Materials, North American Edition (1992). Preferred emulsifiers are nonionic surfactants/emulsifiers. Non limiting useful emulsifiers herein include those selected from the group consisting of alkyl glucosides, alkyl polyglucosides, polyhydroxy fatty acid amides, alkoxylated fatty acid esters, sucrose esters, alkoxylated fatty alcohols, amine oxides, and mixtures thereof. Most preferred are alkoxylated fatty alcohols and alkyl glucosides and mixtures thereof.

In one embodiment the fluid composition comprises less than about 5%, or less than about 3%, or less than about 2% of one or more lathering surfactants. In one embodiment the fluid is free or substantially free of lathering surfactants. A lathering surfactant is defined as a surfactant which when combined with water and mechanically agitated generate a foam or later. Lathering surfactants include anionic and amphoteric lathering surfactants and mixtures thereof. Anionic lathering surfactants include sarcosinates, sulfates, sulfonate, isethionate, taurates, phosphates, lactylates, glutamates, alkali metal salts of fatty acids (i.e. soaps) having from 8 to 24 carbons, and mixtures thereof.

### Lubricants

The fluid compositions may employ one or more lubricants, from about 0.1% to about 8%, alternatively from about 0.1% to about 5%, alternatively from about 0.2% to about 3%, by weight of the composition. Exemplary lubricants include lubricous water soluble polymers, water insoluble particles, and hydrogel-forming (or water swellable) polymers, and mixtures thereof.

Useful lubricious water soluble polymers may have a molecular weight greater between about 300,000 and 15,000,000 Daltons, preferably more than about one million Daltons. Non-limiting examples of suitable lubricious water soluble polymers include polyethylene oxide, polyvinylpyrrolidone, and polyacrylamide. Non limiting useful water insoluble particles may include inorganic particles or organic polymer particles. Hydrogel-forming polymers are typically highly hydrophilic polymers that, in water, form organized three-dimensional domains of approximately nanometer scale. Additional polymer lubricants include: cellulose derivatives such hydroxyalkyl cellulose polymers such as hydroxyethyl cellulose and hydroxypropyl cellulose, carboxymethyl cellulose, and cellulose methyl ether and polysaccharide gums such as, for example, xanthan gum, carrageenan gum, guar gum, locust bean gum, and hydroxypropyl guar gum.

### Sensates

In one embodiment of the invention, the composition may contain sensates, or combinations of sensates. Sensates can be materials that provide the sensation of a thermal change, e.g., heating or cooling. Applicants have found that the addition of sensates using this composition provides longer lasting skin sensation and comfort benefits. Non-limiting examples include: p-Methane-3, 8-diol; Isopulegol; Menthoxypropane-1,2,-diol; Curcumin; Menthyl Lactate; Gingerol; Icilin; Menthol; Tea Tree Oil; Methyl Salicylate; Camphor; Peppermint Oil; N-Ethyl-p-menthane-3-carboxamide; N-[4-(Cyanomethyl)phenyl]-2-isopropyl-5-methylcyclohexane-carboxamide; Ethyl 3-(p-menthane-3-carboxamido)acetate; 2-Isopropyl-N,2,3-trimethylbutyramide; Menthone glycerol ketal, and mixtures thereof.

### Gel Network

The fluid composition is preferably substantially free from a gel network phase. As used herein, the term “gel network” refers to a lamellar or vesicular solid crystalline phase which comprises at least one fatty amphiphile. The present invention contains less than about 3%, alternatively less than about 1%, alternatively less than about 0.5% of at least one fatty amphiphiles. Gel networks have been found to reduce the rinse profile of these systems. Fatty alcohol gel networks have been used for years in cosmetic creams and hair conditioners. Gel networks are a re-solidified liquid crystal gel phase formed by fatty amphiphiles (e.g. cetyl or stearyl alcohol) and a hydrophilic phase (e.g. water). It is formed by undergoing a melting and then re-solidification process in the hydrophilic phase. The gel network will typically have a lower thermal transition than the melt temperature of the fatty amphiphile itself.

### Optional Ingredients

The fluid composition may further comprise additional optional ingredients. Suitable additional optional ingredients include perfume, preservatives, chelants, sensates (e.g. menthol), desquamation actives, anti-acne actives, anti-wrinkle/anti-atrophy actives, anti-oxidants/radical scavengers, flavonoids, anti-inflammatory agents, anti-cellulite agents, topical anesthetics, tanning actives, skin lightening agents, skin soothing and healing actives, antimicrobial actives, sunscreen actives, visual skin enhancers, humectants and moisturizing agents (e.g., glycerin, glycols, sorbitol) and the like. Such optional ingredients are described more fully in U.S. application Ser. No. 11/367,918, filed Mar. 3, 2006. Preferred additional optional ingredients include salicylic acid, opacifiers (e.g. mica and titanium dioxide), perfume, hydrophilic conditioning agents (e.g., glycerin) and skin sensates (e.g. menthol).

The fluid composition may contain salicylic acid, its isomers, tautomers, salts and derivatives thereof. Alternatively, the compositions comprise from about 0.001% to about 5% salicylic acid. Alternatively, the compositions comprise from about 0.01% to about 2% salicylic acid. Alternatively, the compositions comprise from about 0.1% to about 1% salicylic acid. Without wishing to be bound by theory, it is believed that salicylic acid is efficacious for the treatment of acne on the skin. Moreover, the salicylic acid is capable of treating and/or reducing the presence of acne on the skin. Such treatment with the shave care composition of this invention involves applying the shave care composition to the skin via the razor and shaving the skin that has been treated with the shave care composition.

Derivatives of salicylic acid include, but are not limited to, any compounds wherein the CH3 groups are individually or in combination replaced by amides, esters, amino groups, alkyls, and alcohol esters. Tautomers of salicylic acid are the isomers of salicylic acid which can change into one another with ease so that they ordinarily exist in equilibrium. Thus, tautomers of salicylic acid can be described as having the chemical formula C7H6O3 and generally having a similar structure to salicylic acid.

The compositions of the present invention may include from about 0.001% to about 5%, alternatively from about 0.01% to about 2%, and alternatively from about 0.1% to about 1%, of alpha- or beta-hydroxy acids, and derivatives, salts, isomers and tautomers thereof. Non-limiting examples of alpha- and beta-hydroxy acids include alpha-hydroxy-butyric acid, alpha-hydroxyisobutyric acid, alpha-hydroxyisocaproic acid, alpha-hydroxyisovaleric, atrolactic acid, beta-hydroxybutyric acid, beta-phenyl lactic acid, beta-phenylpyruvic acid, citric acid ethyl pyruvate, galacturonic acid, glucoheptonic acid, glucoheptono 1,4-lactone, gluconic acid, gluconolactone glucuronic acid, glucuronolactone, glycolic acid, isopropyl pyruvate, lactic acid, malic acid, amndelic acid, emthyl pyruvate, mucic acid, pyruvic acid, saccharic acid, saccharic acid 1,4-lactone, tartaric acid and tartronic acid, and mixtures thereof.

Opacifiers may be added to the shave care composition of the present invention. Opacifiers may be either inorganic or organic compounds. Inorganic opacifiers include, for example, titanium dioxide, zinc oxide, talc, mica or coated mica (with oxides of titanium, tin, or iron or bismuth oxychloride), magnesium aluminum silicate, bismuth oxychloride, or other minerals. These compounds can be added as powders, dispersions, or complexes. Organic opacifiers include, for example, opaque emulsions (e.g., containing Styrene/PVP copolymer, vinyl polymers, or latexes), metal salts of amines containing 14-20 carbon atoms per molecule, alkanolamides containing 14-20 carbon atoms per molecule, organic alcohols containing 14-20 carbon atoms per molecule, insoluble salts of stearic acid, glycol mono- or distearates, propylene glycol and glycerol monostearates and palmitates. Combinations of these opacifiers can also be used. The opacifying additive is typically included in an amount of about 1 to about 6%, preferably about 2 to about 5%, by weight of the composition.

The fluid compositions may include depilatory actives including any keratin reducing agents such as sulphide salts, thioglycol, thioglycerol, thioglycomide, thioglycolhydrazide thioglycolic acid, thioglycolate salts such as potassium, calcium and ammonium, thiosalicylic acid, thiomalic acid, ammonium thiolactic acid, cysteine and cysteamine. The reducing agent is present at amounts of from about 0.1% to 20%, preferably 0.2% to 15%, more preferably from 0.5% to 10% by weight of the composition. Preferably the depilatory composition may further comprise a base to control pH such as sodium or potassium hydroxide, ammonia alkanolamides such as monoethanolamide and mixtures thereof.

### Kits

The disposable fluid dispensing hair removal devices may be provided as a single device or may be provided as a kit comprising said device and at least one, preferably at least two, more preferably at least 3 additional sealed handles containing a fluid. The additional handles may be substantially identical in size and composition to the original handle of the device or may be of a different size and or composition. The provision of multiple handles containing different fluids enables the consumer to select the handle depending on the particular need. Additional replacement or refill handles may also be provided independently of the device. In another embodiment, the kit may also provide one or more replacement hair removal devices, such as razor cartridges which can be attached to the chassis. Alternatively, such replacement hair removal devices may be provided independently of the device and or kit thereof.

### Specific Embodiments

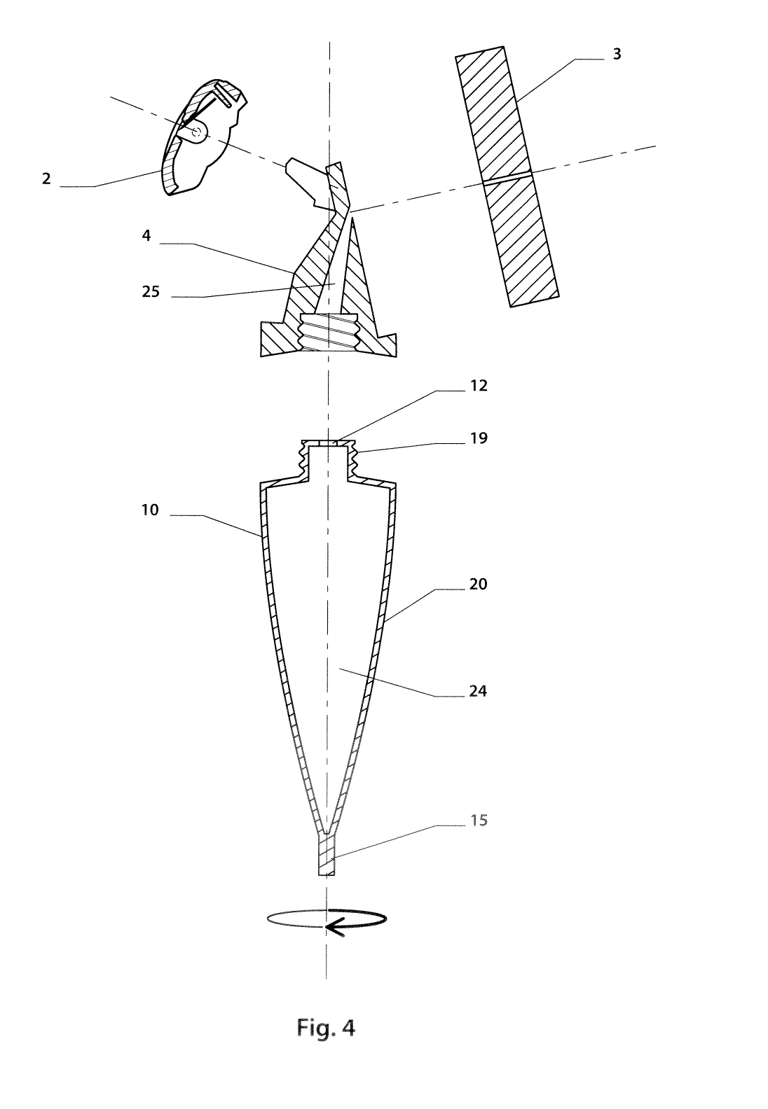

The invention will now be further described with reference to specific embodiments of the invention. FIGS. 1a and 1b describe a front and rear perspective of a first embodiment of the invention. FIG. 2 shows an exploded view thereof. FIG. 3 shows a cross section thereof and FIG. 4 shows an exploded cross section thereof. This first embodiment comprises a hair removal means (2) having at least one razor blade provided in a housing located on the upper portion (5) of the front surface (7) of the device (1). A fluid dispensing means (3) is located on the upper portion (5) of the back surface (8). The fluid dispensing means (3) comprises a sponge which extends substantially across the entire width of the back surface (8) of the upper portion (5). The hair removal means (2) and the fluid dispensing means (3) are arranged in a predetermined position such that they are substantially diametrically opposed and face the respective skin contacting surface. The hair removal means (2) and fluid dispensing means (3) are attached to a chassis (4). The chassis (4) is releasably attached to the seamless extruded tube forming the hollow handle (10) via a screw thread on the neck portion (19) of the handle (10) formed from injection overmolding. The hollow handle (10) has a sealed dispensing aperture (12) which upon opening is in liquid communication with the fluid dispensing means (3). The hollow handle reservoir (10) is provided with a tab opening means (11). The hair removal means (2) and fluid dispensing means (3) are sealed and protected by a release layer opening means (13) not shown which can be readily removed by the user of the device.

FIG. 5 show cross sections of a second, third and fourth embodiment of the invention; wherein the hair removal means and fluid dispensing means are located at an acute angle, 90° and 180° respectively between the hair removal means normal and fluid dispensing normal (Nhr and Nfa).

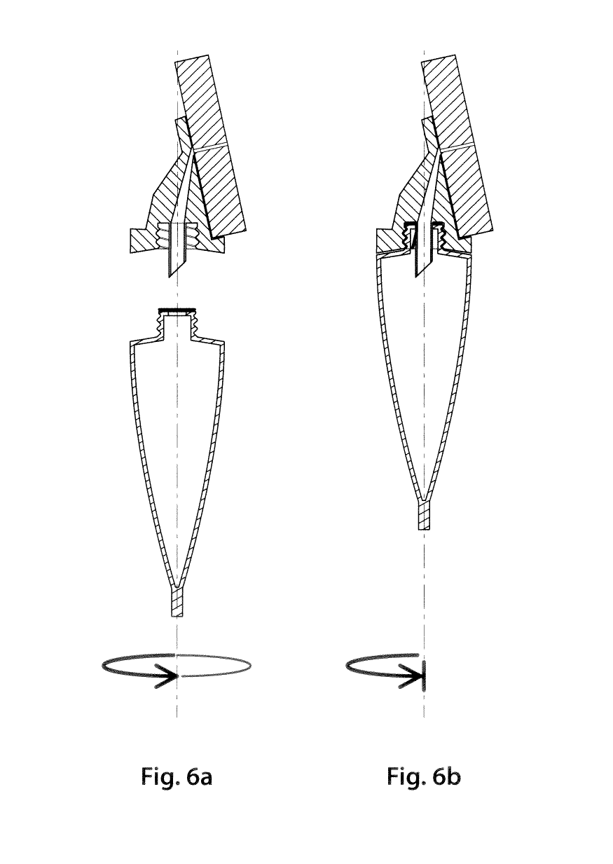

FIGS. 6a and 6b show a partial exploded cross section and a cross section of a fifth embodiment of the invention (hair removal means not shown) wherein the chassis fluid channel (25) extends into the interior cavity (24) of the handle (10).

FIGS. 7a and 7b show a partial cross section of a sixth embodiment of the invention (hair removal means not shown) wherein the handle aperture and the dispensing means aperture is sealed with a stopper insert.

### Method of Use

The hair removal and fluid dispensing devices of the invention provide a simple and convenient method to effectively remove hair from the body. The consumer typically removes any cap or release layer present to protect the hair removal means or fluid dispensing means. The consumer then opens the handle aperture and where applicable removes the opening means there from. Optionally the consumer may apply pressure against the handle to facilitate the flow of fluid from the handle to the fluid dispensing means. The consumer then places the fluid dispensing means on the skin surface to be treated and applies a force so that the fluid dispensing means is optionally in its in use deflected position as shown in FIG. 11 and applies the fluid using the dispensing means to the surface to be treated. The device is then rotated and optionally the consumer applies a force so that the hair removal means is optionally in its in use deflected position and applies the hair removal device to the same surface to remove the hair. The process is then repeated on the same or additional surfaces until the desired hair removal is achieved. In addition the consumer may position and apply the fluid dispensing means over the same surface after the hair removal step in order to collect and remove any debris or excess composition from the skin surface and or provide the skin with a leave on formulation. Alternatively, the consumer may utilize the hair removal means first before the fluid dispensing means, which may be used to deliver after shave composition. The hair removal and fluid dispensing device of the present invention does not require a source of water in order to function, in particular the skin does not require wetting or the application of any pre and or post shave composition. Moreover the device does not require any post use rinsing. Nevertheless in situations where water is available the consumer may utilize water before after or during the fluid application and hair removal process. If, the device is intended for multiple use, the user may consider rinsing after use before replacing the cap if present and storing the device if water is available or at a later time point. The device may thus be used again.

In a preferred embodiment the handle may be replaced once the contents are depleted. The used handle may be simply detached from the chassis and hair removal means and fluid dispensing means (which are typically maintained in position by the chassis) and subsequently disposed of. The empty handle may then be replaced by a full sealed handle which is attached to the chassis. Such a configuration also enables the components of the device to be recycled. Similarly, the hair removal means and or fluid dispensing means if releasably attached to the chassis can be removed and replaced if necessary or alternatively the chassis hair removal means and fluid dispensing means can be removed from the handle and replaced. This find particular utility for handles with a capacity intended for multiple consumer usage.

### Combinations

A. A hair removal and fluid application device having a flexible hollow handle to contain and expel a fluid contained therein, a hair removal means, a fluid dispensing means and a chassis to connect said hollow handle, said hair removal means and said fluid dispensing means to one another, wherein said hollow handle is releasably attached to said chassis and wherein said hair removal means and said fluid dispensing means are attached to said chassis in a substantially predetermined position such that the hair removal means and fluid dispensing means are used independently of one another.
B. The hair removal and fluid application device according to Paragraph A, wherein said device has a sealed dispensing aperture.
C. The hair removal and fluid application device according to either Paragraphs A or B, wherein said hollow handle is in liquid communication with said chassis.
D. The hair removal device according to Paragraph C, wherein said chassis comprises a fluid channel.
E. The hair removal and fluid application device according to Paragraph A, wherein at least one of said hair removal means and said fluid dispensing means is permanently attached to said chassis, preferably wherein both of said hair removal means and said fluid dispensing means are permanently attached to said chassis.
F. The hair removal and fluid application device according to Paragraph A, wherein each of said hair removal means and said fluid dispensing means has a respective skin contacting surface, wherein said skin contacting surface of said hair removal means is positioned in substantially the opposing direction to skin contacting surface of said fluid dispensing means.
G. The hair removal and fluid application device according to Paragraph A, further comprising an opening means.
H. The hair removal and fluid application device according to Paragraph F, wherein said opening means comprises a tab, thread or string.
I. The hair removal and fluid application device according to Paragraph A, wherein said hair removal means comprises at least one blade, preferably a blade and housing.
J. The hair removal and fluid application device according to Paragraph A, wherein said fluid dispensing means is an open cell foam or a closed cell foam.
K. The hair removal and fluid application device according to Paragraph A, wherein said handle is in fluid communication with said fluid dispensing means and wherein said fluid dispensing means has at least one aperture in fluid communication with said handle and chassis.
L. The hair removal and fluid application device according to Paragraph A, wherein said device further comprises a removable cover or release liner, preferably to cover at least one of said hair removal means and or said fluid dispensing means.
M. The hair removal and fluid application device according to Paragraph A, wherein said hollow handle contains a fluid composition comprising at least 80% by weight water and from 0.1% to 5% by weight of a thickening agent.
N. The method to dispense fluid and remove hair comprising the steps of contacting a skin surface with the hair removal means or fluid dispensing means of a device according to Paragraph A, and applying a force onto the device.
O. The hair removal and fluid dispensing kit comprising a hair removal and fluid application device according to Paragraph A and at least one additional sealed fluid filled hollow handle and optionally at least one additional hair removal means.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair removal and fluid application device having a flexible hollow handle to contain and expel a fluid contained therein, a hair removal means, a fluid dispensing means and a chassis to connect said hollow handle, said hair removal means and said fluid dispensing means to one another, wherein said hollow handle is releasably attached to said chassis and wherein said hair removal means and said fluid dispensing means are attached to said chassis in a substantially predetermined position such that the hair removal means and fluid dispensing means are used independently of one another.

2. The hair removal and fluid application device according to claim 1, wherein said device has a sealed dispensing aperture.

3. The hair removal and fluid application device according to claim 1, wherein said hollow handle is in liquid communication with said chassis.

4. The hair removal device according to claim 3, wherein said chassis comprises a fluid channel.

5. The hair removal and fluid application device according to claim 1, wherein at least one of said hair removal means and said fluid dispensing means is permanently attached to said chassis, preferably wherein both of said hair removal means and said fluid dispensing means are permanently attached to said chassis.

6. The hair removal and fluid application device according to claim 1, wherein each of said hair removal means and said fluid dispensing means has a respective skin contacting surface, wherein said skin contacting surface of said hair removal means is positioned in substantially the opposing direction to skin contacting surface of said fluid dispensing means.

7. The hair removal and fluid application device according to claim 1, further comprising an opening means.

8. The hair removal and fluid application device according to claim 6, wherein said opening means comprises a tab, thread or string.

9. The hair removal and fluid application device according to claim 1, wherein said hair removal means comprises at least one blade, preferably a blade and housing.

10. The hair removal and fluid application device according to claim 1, wherein said fluid dispensing means is an open cell foam or a closed cell foam.

11. The hair removal and fluid application device according to claim 1, wherein said handle is in fluid communication with said fluid dispensing means and wherein said fluid dispensing means has at least one aperture in fluid communication with said handle and chassis.

12. The hair removal and fluid application device according to claim 1, wherein said device further comprises a removable cover or release liner, preferably to cover at least one of said hair removal means and or said fluid dispensing means.

13. The hair removal and fluid application device according to claim 1, wherein said hollow handle contains a fluid composition comprising at least 80% by weight water and from 0.1% to 5% by weight of a thickening agent.

14. A method to dispense fluid and remove hair comprising the steps of contacting a skin surface with the hair removal means or fluid dispensing means of a device according to claim 1, and applying a force onto the device.

15. A hair removal and fluid dispensing kit comprising a hair removal and fluid application device according to claim 1 and at least one additional sealed fluid filled hollow handle and optionally at least one additional hair removal means.
